(19) United States
(12) Patent Application Publication
(10) Pub. No.: US 2025/0279642 A1
(43) Pub. Date: Sep. 4, 2025

(54) IMAGE FORMING APPARATUS AND METHOD FOR CONTROLLING IMAGE FORMING APPARATUS

(71) Applicants: Tomoyuki Yamashita, KANAGAWA (JP); Shuntaroh Nakayama, KANAGAWA (JP); Takahiko Hasegawa, KANAGAWA (JP); Junichi Sasaki, KANAGAWA (JP); Yoshiteru Hagiwara, KANAGAWA (JP); Kentaroh Kajita, KANAGAWA (JP); Tatsuya Ogino, KANAGAWA (JP); Kozaburo Suzuki, KANAGAWA (JP)

(72) Inventors: Tomoyuki Yamashita, KANAGAWA (JP); Shuntaroh Nakayama, KANAGAWA (JP); Takahiko Hasegawa, KANAGAWA (JP); Junichi Sasaki, KANAGAWA (JP); Yoshiteru Hagiwara, KANAGAWA (JP); Kentaroh Kajita, KANAGAWA (JP); Tatsuya Ogino, KANAGAWA (JP); Kozaburo Suzuki, KANAGAWA (JP)

(73) Assignee: Ricoh Company, Ltd., Tokyo (JP)

(21) Appl. No.: 19/055,942

(22) Filed: Feb. 18, 2025

(30) Foreign Application Priority Data
Mar. 4, 2024 (JP) 2024-031852

(51) Int. Cl. H02H 3/20; H02H 5/04

(52) U.S. Cl. CPC H02H 3/20; H02H 5/04

(57) ABSTRACT

An image forming apparatus includes an image forming device, a voltage detector, a switch, a functional unit, a state detector, and circuitry. The image forming device forms an image based on an alternating current (AC) voltage input therein. The voltage detector detects a value of the AC voltage. The switch switches between a conductive state and a cutoff state of a current path of the AC voltage to the voltage detector. The functional unit generates heat or allow a current to flow in response to the AC voltage. The state detector detects a temperature or the current of the functional unit. The circuitry estimates the value of the AC voltage based on the temperature or the current detected by the state detector and 10 switches the switch from the cutoff state to the conductive state when the value of the AC voltage estimated by the circuitry indicates a sign of overvoltage.

### CROSS-REFERENCE TO RELATED APPLICATION

This patent application is based on and claims priority pursuant to 35 U.S.C. § 119(a) to Japanese Patent Application No. 2024-031852, filed on Mar. 4, 2024, in the Japan Patent Office, the entire disclosure of which is hereby incorporated by reference herein.

### BACKGROUND

### Technical Field

Embodiments of the present disclosure relate to an image forming apparatus and a method for controlling the image forming apparatus.

### Related Art

In a power supply, a technique is known in which when overvoltage is input from an alternating current (AC) power supply, a warning message is displayed on a display panel or the input of the AC power supply is interrupted by interrupting a fuse or controlling a relay. Further, a technique is also known in which an auxiliary power supply having a smaller power supply capacity than a switching power supply is disposed, the charging voltage of a capacitor of the auxiliary power supply is detected, and the magnitude of the AC voltage is determined based on the detected charging voltage.

### SUMMARY

In an embodiment of the present disclosure, an image forming apparatus includes an image forming device, a voltage detector, a switch, a functional unit, a state detector, and circuitry. The image forming device forms an image based on an alternating current (AC) voltage input from an external device. The voltage detector detects a value of the AC voltage. The switch switches between a conductive state and a cutoff state of a current path of the AC voltage to the voltage detector. The functional unit generates heat or allow a current to flow in response to the AC voltage. The state detector detects a temperature or the current of the functional unit. The circuitry estimates the value of the AC voltage based on the temperature or the current detected by the state detector and switches the switch from the cutoff state to the conductive state when the value of the AC voltage estimated by the circuitry indicates a sign of overvoltage.

In another embodiment of the present disclosure, a method is for controlling an image forming apparatus that includes an image forming device to form an image based on an AC voltage input from an external device, a functional unit to generate heat or allowing a current to flow in response to the AC voltage, a voltage detector, a switch, a state detector, and circuitry. The method includes detecting a value of the AC voltage by the voltage detector, switching between a conductive state and a cutoff state of a current path of the AC voltage to the voltage detector by the switch, detecting a temperature or the current of the functional unit by the state detector, estimating, by the circuitry, the value of the AC voltage based on the temperature or the current detected by the state detector, and switching, by the circuitry, the switch in the cutoff state to the conductive state.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective sectional view of an overall configuration of an image forming apparatus according to a first embodiment of the present disclosure;

FIG. 2 is a block diagram of the image forming apparatus of FIG. 1;

FIG. 3 is a diagram illustrating a relation among the value of an alternating current (AC) voltage for turning on a switch in an energy saving mode, the value of an AC voltage for displaying a warning message on an operation panel of FIG. 2, and the value of an AC voltage for shutting off a power interrupter of FIG. 2;

FIG. 4 is a diagram of a warning message displayed on the operation panel;

FIG. 5 is a flowchart of an operation for protecting the power supply of FIG. 2 from overvoltage;

FIG. 6 is a block diagram of a part of an image forming apparatus according to a second embodiment of the present disclosure;

FIG. 7 is a flowchart of an operation for protecting a power supply of FIG. 6 from overvoltage;

FIG. 8 is a flowchart of another operation for protecting the power supply of FIG. 6 from overvoltage;

FIG. 9 is a block diagram of an image forming apparatus according to a third embodiment of the present disclosure;

FIG. 10 is a flowchart of an operation for protecting a power supply of FIG. 9 from overvoltage;

FIG. 11 is a block diagram of an image forming apparatus according to a fourth embodiment of the present disclosure;

FIG. 12 is a flowchart of an operation for protecting a power supply of FIG. 11 from overvoltage; and

FIG. 13 is a block diagram of a hardware configuration of a controller illustrated in FIGS. 1 and 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In each drawing, like reference signs are assigned to like elements or components and descriptions of those elements or components may be simplified or omitted. As used herein, the singular forms “a,” “an,” and “the” are intended to include the plural forms as well, unless the context clearly indicates otherwise.

In the following description, the same or like reference sign as the voltage name is used for the voltage line through which the voltage is transmitted.

### First Embodiment

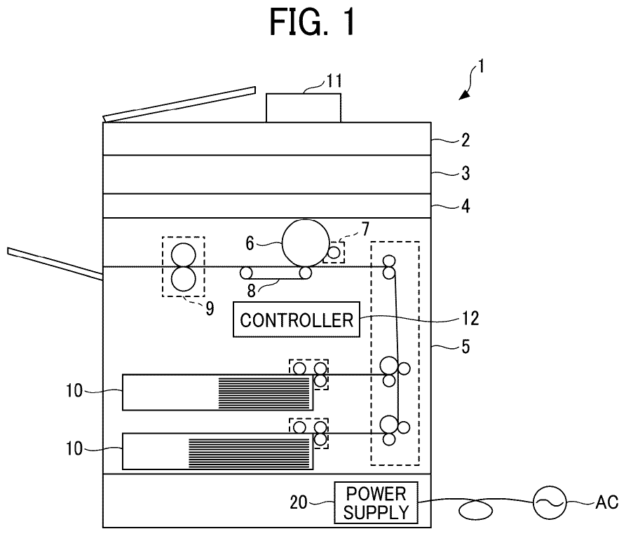

FIG. 1 is a perspective sectional view of an overall configuration of an image forming apparatus according to an embodiment of the present disclosure. An image forming apparatus 1 illustrated in FIG. 1 is a digital multi-function peripheral (MFP) having, for example, a facsimile function and one or more of a copying function, a printing function, and a scanner function.

For example, the image forming apparatus 1 includes an automatic document feeder (ADF) 2, an image reading device 3, a writing unit 4, a printer unit 5, an operation unit 11, a controller 12, and a power supply 20. The printer unit 5 includes a photoconductor drum 6, a developing device 7, a conveying belt 8, a fixing device 9, and a storage space in which a sheet feed tray 10 is stored.

The image forming apparatus 1 can sequentially switch among a copier function, a printer function, and a facsimile function with an application switch key on the operation unit 11 of the image forming apparatus 1. A user selects the copy function to set the image forming apparatus 1 in a copy mode, selects the print function to set the image forming apparatus 1 in a printer mode, and selects the facsimile function to set the image forming apparatus 1 in a facsimile mode.

The image forming apparatus 1 switches the internal condition to a normal mode, an energy saving mode, in accordance with the condition of an internal circuit. For example, the normal mode includes an operation mode (operating state) in which a facsimile function, a copying function, a printing function, or a scanner function is realized and a standby mode (standby state).

The standby mode is a mode in which the power supply 20 generates various voltages and supplies the voltages to the functional units, and thus the functional units can immediately operate based on an operation instruction. The energy saving mode is a mode in which the supply of power from the power supply 20 is stopped except for the functional units that operate in the energy saving mode, and for example, the supply of power is stopped to the printer unit 5 to stop the image forming operation by the printer unit 5. The transition from the energy saving mode to the standby mode or the operation mode and the transition from the standby mode to the operation mode are switched by an operation of the operation unit 11 by a user of the image forming apparatus 1 or control (of, e.g., receiving a facsimile) in the image forming apparatus 1.

The power supply 20 is connected to a commercial alternating current (AC) power supply via a power supply cable. The power supply 20 generates various direct current (DC) voltages used in, for example, the automatic document feeder 2, the image reading device 3, the writing unit 4, the printer unit 5, and the operation unit 11, using an AC voltage supplied from the commercial AC power supply. The power supply 20 includes a first power supply system and a second power supply system. The first power supply system supplies power in the normal mode and stops the supply of power in the energy saving mode and when the image forming apparatus 1 is powered off. The second power supply system supplies power in any of the normal operation, the energy saving mode, and when the image forming apparatus 1 is powered off.

The printer unit 5 forms a toner image to be transferred onto a paper medium based on image data of a document or facsimile data to form an image onto the paper medium. The printer unit 5 is an example of an image forming device that forms an image. A brief description is given below of a flow of image formation in the image forming apparatus 1, which is a case where the operation mode is set to the copy mode.

In the copy mode, a stack of documents (a plurality of documents) to be copied is set on the automatic document feeder 2, or a document to be copied is set on the image reading device 3. When a start button displayed on the operation unit 11 is pressed, the automatic document feeder 2 feeds documents one by one to the image reading device 3. The image reading device 3 reads image data of each of the documents sequentially fed from the automatic document feeder 2 or the document set on the image reading device 3.

The writing unit 4 converts the image data read by the image reading device 3 into optical data. The photoconductor drum 6 is uniformly charged by a charger disposed at a position facing the photoconductor drum 6, and then exposed to laser light including optical data converted by the writing unit 4. An electrostatic latent image is formed on the photoconductor drum 6 by the exposure of the writing unit 4. The developing device 7 develops the electrostatic latent image on the photoconductor drum 6 to form a toner image on the photoconductor drum 6. The toner image formed on each photoconductor drum 6 is transferred on to a paper medium by the conveying belt 8. The fixing device 9 fixes the toner image to the paper medium. The paper medium on which the image of the document is copied is ejected from an ejection section. The operation unit 11 receives various inputs according to user operations and displays various information on a display of the operation unit 11.

The controller 12 may be a central processing unit (CPU) mounted on a control board, and controls the entire operation of the image forming apparatus 1. The controller 12 operates by receiving power from a battery (e.g., a secondary battery) even when the image forming apparatus 1 is in the energy saving mode. The controller 12 always operates by receiving power from the second power supply system. The controller 12 is an example of a controller.

FIG. 1 illustrates an example in which the image forming apparatus 1 is a digital multi-function peripheral. However, the image forming apparatus 1 may be an image forming apparatus having a single function such as a scanner, a printer, or a facsimile.

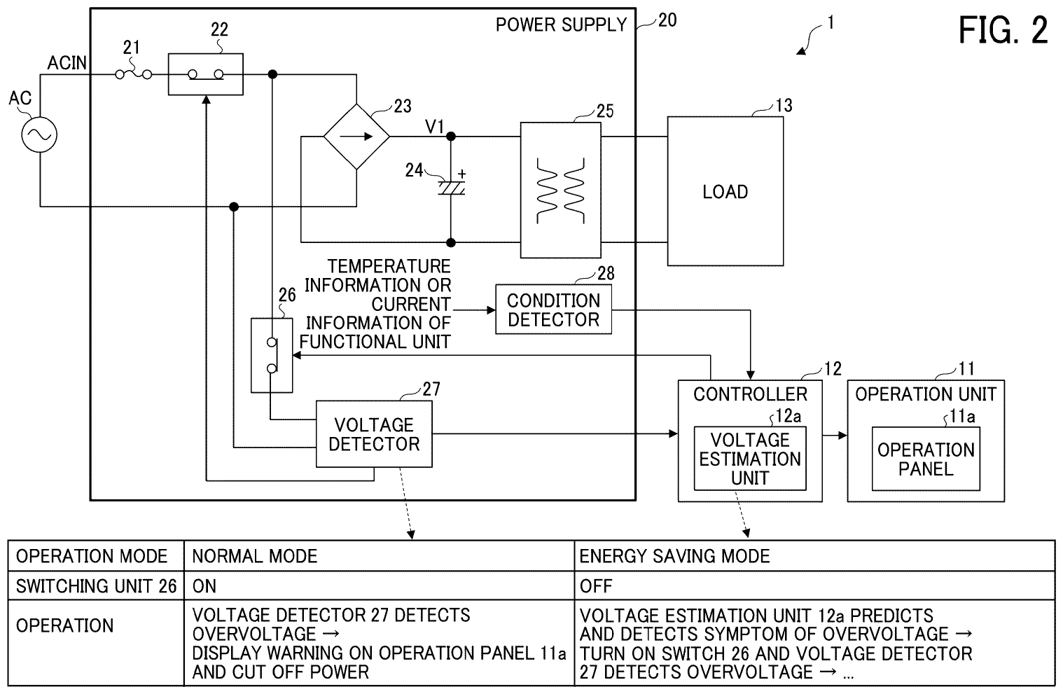

FIG. 2 is a block diagram illustrating an example of the image forming apparatus 1 in FIG. 1. The power supply 20 is connected to a commercial AC power supply via a power supply cable, and has a function of supplying power to a load 13 using an AC voltage supplied from the commercial AC power supply. For example, the power supply 20 may be a switching power supply that smooths an AC voltage ACIN received from an AC power supply and further converts the voltage to generate a DC voltage to be supplied to the load 13.

The load 13 may be, for example, the automatic document feeder 2, the image reading device 3, the writing unit 4, the printer unit 5, the operation unit 11, or the controller 12, illustrated in FIG. 1. The apparatus or device on which the power supply 20 is mounted is not limited to the image forming apparatus 1 illustrated in FIG. 1, and may be an electronic device such as a projector, an electronic blackboard, a digital signage, an imaging apparatus, a personal computer (PC), or a server.

The power supply 20 includes a fuse 21, a power interrupter 22, a rectifier circuit 23, an electrolytic capacitor 24, a DC/DC converter 25, a switch 26, a voltage detector 27, and a state detector 28.

The fuse 21 is disposed between an input terminal that receives a voltage input line ACIN and the power interrupter 22, and is cut off (blown) when a blowing current determined by the electrical specification of the fuse flows, thereby protecting the power supply 20 from overcurrent. The power interrupter 22 is disposed between the fuse 21 and the rectifier circuit 23, and cuts off the supply of the AC voltage ACIN to the rectifier circuit 23 in response to a control signal from the voltage detector 27. The power interrupter 22 operates by receiving power from the battery even in the energy saving mode.

The rectifier circuit 23 is, for example, a full-wave rectifier circuit including a diode bridge, and rectifies the AC voltage ACIN and outputs the rectified voltage as a DC voltage (pulsating current) to a voltage line V1. The electrolytic capacitor 24 stores and smooths the voltage (pulsating current) output from the rectifier circuit 23, and generates a DC voltage V1 depending on the amplitude of the AC voltage ACIN in the voltage line V1. The electrolytic capacitor 24 stores the DC voltage V1 obtained by rectifying the AC voltage ACIN received in the normal mode and the energy saving mode. The DC/DC converter 25 generates one or more DC voltages to be supplied to the load 13 based on the DC voltage V1.

The switch 26 is disposed between the power interrupter 22 and the voltage detector 27. The switch 26 is set to a conductive state (ON) by a control signal received from the controller 12 during the normal mode of the image forming apparatus 1, and supplies the AC voltage ACIN to the voltage detector 27. As described with reference to FIG. 1, the normal mode is an operation mode or a standby mode in which the facsimile function, the copying function, the printing function, or the scanner function is implemented.

The switch 26 is set to a cutoff state (OFF) by a control signal received from the controller 12 during the energy saving mode of the image forming apparatus 1, and stops the supply of the AC voltage ACIN to the voltage detector 27. However, the switch 26 is turned on when the switch 26 has received a control signal from the controller 12 during the energy saving mode, and supplies the AC voltage ACIN to the voltage detector 27.

The voltage detector 27 operates by the AC voltage ACIN received while the switch 26 is on (e.g., during the normal mode), and detects whether the AC voltage ACIN is overvoltage. The voltage detector 27 notifies the controller 12 of a detection result (whether overvoltage has occurred) of the AC voltage ACIN. When the notification from the voltage detector 27 indicates an excessive voltage of the AC voltage ACIN, the controller 12 displays a warning message on an operation panel 11a of the operation unit 11. Such a configuration can notify a user of the image forming apparatus 1 of the occurrence of overvoltage. The operation panel 11a is an example of the display.

When the voltage detector 27 has detected the overvoltage of the AC voltage ACIN, the voltage detector 27 outputs a control signal that shuts off power interrupter 22 to the power interrupter 22. Since the power interrupter 22 is shut off when overvoltage occurs, the supply of the overvoltage to the inside of the power supply 20 can be prevented. Thus, the power supply 20 is protected from the overvoltage.

While the switch 26 is off in the energy saving mode, the voltage detector 27 does not receive the AC voltage ACIN and thus stops operating. Such a configuration can reduce power consumption in the energy saving mode as compared with other power supplies that perform the operation of detecting an AC voltage also in an energy saving mode. The overvoltage state of the AC voltage ACIN may occur also in the energy saving mode.

Accordingly, when the switch 26 is turned on by the control of the controller 12 during the energy saving mode, the voltage detector 27 receives the AC voltage ACIN to operate and thus detects the value of the AC voltage ACIN. When the voltage detector 27 has detected the overvoltage of the AC voltage ACIN, the voltage detector 27 outputs a control signal that shuts off power interrupter 22 to the power interrupter 22. In this way, the voltage detector 27 operates only when there is a possibility that the power supply 20 may need to be protected during the energy saving mode.

The state detector 28 detects the temperature of a functional unit that generates heat in response to the AC voltage ACIN, or detects the value of a current flowing through the functional unit in response to the AC voltage ACIN. The state detector 28 notifies the controller 12 of information indicating the detected temperature or current value of the functional unit. For example, the functional unit is a heat generating component or a component that consumes current, which is mounted on the image forming apparatus 1 (including the power supply 20) and is energized even in the energy saving mode. The temperature of the functional unit may be not only the temperature of the functional unit itself but also the ambient temperature of the functional unit. The current of the functional unit is a current flowing through the functional unit (i.e., a consumption current).

The controller 12 includes a voltage estimation unit 12a that operates during the energy saving mode. The voltage estimation unit 12a estimates the value of the AC voltage ACIN based on the temperature information or the current information of the functional unit notified from the state detector 28. When the value of the AC voltage ACIN estimated by the voltage estimation unit 12a during the energy saving mode indicates a sign of overvoltage, the controller 12 outputs a control signal to the switch 26 to switch the switch 26 from the off state to the on state.

With such a configuration, the voltage detector 27 that has stopped operating in the energy saving mode can be operated when the value of the AC voltage ACIN indicates a sign of overvoltage. Accordingly, the AC voltage ACIN can be directly or indirectly monitored at all times while the AC voltage ACIN minimizes the power consumption in the energy saving mode. When overvoltage has occurred, the supply of the AC voltage ACIN is cut off to protect the components of the power supply 20 from damage.

The table on the lower side of FIG. 2 illustrates an outline of the operations of the switch 26, the voltage detector 27, and the voltage estimation unit 12a. In the normal mode, the switch 26 is turned on. When the voltage detector 27 has detected overvoltage, a warning message is displayed on the operation panel 11a, and a power interrupter 22 cuts off the power supply.

In the energy saving mode, the switch 26 is turned off. When the voltage estimation unit 12a has predicted and detected the sign of overvoltage, the switch 26 is turned on. Thereafter, as in the normal mode, when the voltage detector 27 has detected overvoltage, a warning message is displayed on the operation panel 11a, and the power interrupter 22 cuts off the power supply.

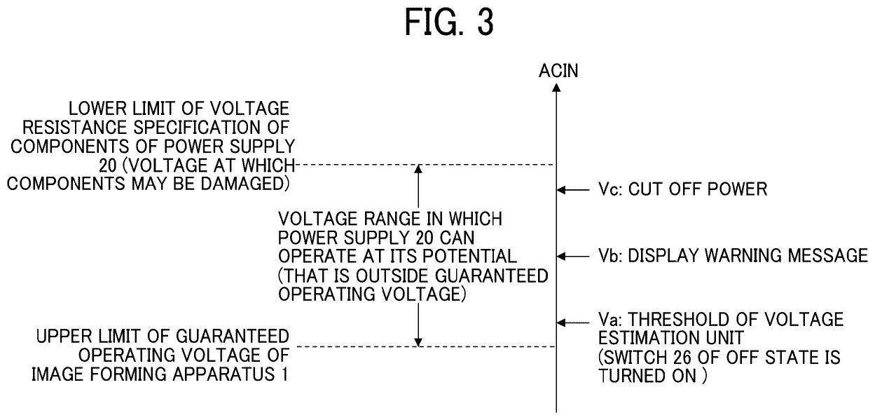

FIG. 3 is a diagram illustrating the relation between the value Va of the AC voltage ACIN at which the switch 26 is turned on in the energy saving mode, the value Vb of the AC voltage ACIN at which the warning message is displayed on the operation panel 11a of FIG. 2, and the value Vc of the AC voltage ACIN at which the power interrupter 22 of FIG. 2 is cut off. In the following description, the values Va, Vb, and Vc of the AC voltage ACIN are also referred to as AC voltages Va, Vb, and Vc, respectively. The AC voltage Va at which the switch 26 is turned on in the energy saving mode is an estimated value by the voltage estimation unit 12a.

The AC voltages Va, Vb, and Vc are preferably higher than the upper limit of the guaranteed operating voltage range of the image forming apparatus 1 and lower than the lower limit of the voltage resistance specification of the components of the power supply 20. The AC voltages Va, Vb, and Vc have the relation in the order of Va<Vb<Vc. Thus, the warning message is displayed when the AC voltage ACIN is equal to or greater than the value Vb. After the warning message is displayed, the supply of the AC voltage ACIN can be interrupted when the AC voltage ACIN is equal to or greater than the value Vc.

In order to enhance the estimation accuracy of the AC voltage Va, it is preferable that the relation between the change in the AC voltage Va and the temperature change indicated by the temperature information of the functional unit or the voltage change indicated by the current information of the functional unit is evaluated in advance using the actual image forming apparatus 1. When the estimation accuracy of the AC voltage Va is sufficiently high, the value Va may be set within the guaranteed operating voltage range. The AC voltages Vb and Vc are preferably set to values at which the warning message is not displayed within the guaranteed operating voltage range and the power supply is not interrupted in consideration of the detection accuracy of the voltage detector 27 because there is a concern that stopping of the operation of the image forming device 1 may occur.

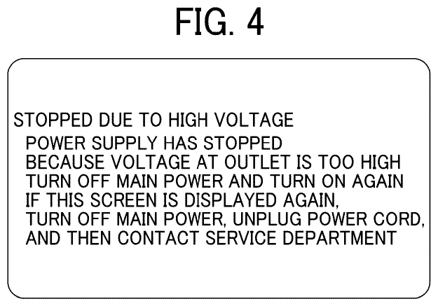

FIG. 4 is a diagram illustrating an example of a warning message displayed on the operation panel 11a. When the AC voltage ACIN is equal to or greater than the value Vb as illustrated in FIG. 3, the warning message illustrated in FIG. 4 is displayed on the operation panel 11a, so that a user of the image forming apparatus 1 can recognize the occurrence of overvoltage and take an appropriate action in response to the warning message.

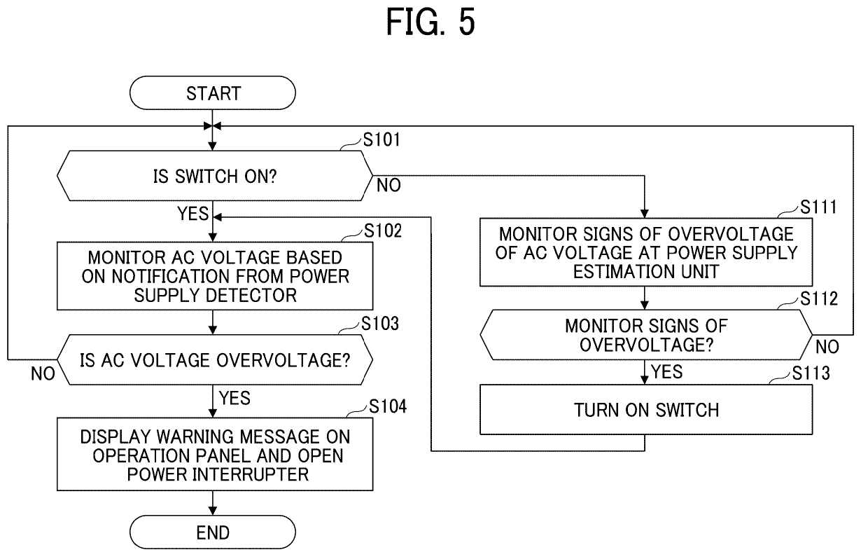

FIG. 5 is a flowchart of an operation for protecting the power supply 20 of FIG. 2 from overvoltage. The procedure illustrated in FIG. 5 is executed by the controller 12.

First, when the switch 26 is on in step S101, the controller 12 performs step S102. When the switch 26 is off in step S101 (in the case of the energy saving mode), the controller 12 performs step S111.

In step S111, the controller 12 monitors the sign of overvoltage of the AC voltage ACIN by the voltage estimation unit 12a. When the voltage estimation unit 12a has detected the sign of overvoltage in step S112, the controller 12 performs step S113. When the voltage estimation unit 12a does not detect the sign of overvoltage in step S112, the controller 12 returns to step S101.

The controller 12 turns on the switch 26 in step S113, and performs step S102. When the switch 26 is turned on, the voltage detector 27 starts the detection operation of the AC voltage ACIN. In other words, the value of the AC voltage ACIN can be accurately detected by the voltage detector 27 based on the detection of the sign of overvoltage by the voltage estimation unit 12a.

In step S102, the controller 12 monitors the AC voltage ACIN based on the detection result of the AC voltage ACIN notified from the voltage detector 27. Next, in step S103, the controller 12 determines whether the AC voltage ACIN is overvoltage. When the AC voltage ACIN is overvoltage, the controller 12 performs step S104. When the AC voltage ACIN is not overvoltage, the controller 12 returns to step S101. For example, the controller 12 may determine overvoltage when the AC voltage ACIN is equal to or greater than the value Vb illustrated in FIG. 3.

In step S104, the controller 12 displays a warning message on the operation panel 11a. The power interrupter 22 is opened by the voltage detector 27 that has detected overvoltage, and the operation illustrated in FIG. 5 is terminated. For example, the voltage detector 27 may open the power interrupter 22 when the AC voltage ACIN is equal to or greater than the value Vc illustrated in FIG. 3.

When the AC voltage ACIN is equal to or greater than the value Vb and is lower than the value Vc, the warning message is displayed, but the power interrupter 22 is not opened. In this case, a user who has viewed the warning message turns off the main power supply of the image forming apparatus 1 once, and thus the operation illustrated in FIG. 5 is completed.

As described above, in the first embodiment, the operation of the voltage detector 27 that detects overvoltage of the AC voltage ACIN is performed in the normal mode and is stopped during the energy saving mode. Such a configuration can reduce power consumption of the power supply 20 and the image forming apparatus 1 in the energy saving mode. In other words, such a configuration can detect the overvoltage of the AC power supply while reducing power consumption.

When the controller 12 turns on the switch 26 in the energy saving mode, the voltage detector 27 starts the detection operation of the overvoltage of the AC voltage ACIN. Such a configuration can directly or indirectly monitor the AC voltage ACIN at all times while reducing power consumption in the energy saving mode. When overvoltage occurs, the supply of the AC voltage ACIN is interrupted, and thus the components of the power supply 20 can be protected from damage.

When the notification from the voltage detector 27 indicates overvoltage of the AC voltage ACIN, the controller 12 displays a warning message on the operation panel 11a of the operation unit 11 to notify a user of the image forming apparatus 1 of the occurrence of overvoltage. The user of the image forming apparatus 1 who has viewed the warning message can recognize the occurrence of overvoltage and take an appropriate action in response to the warning message.

### Second Embodiment

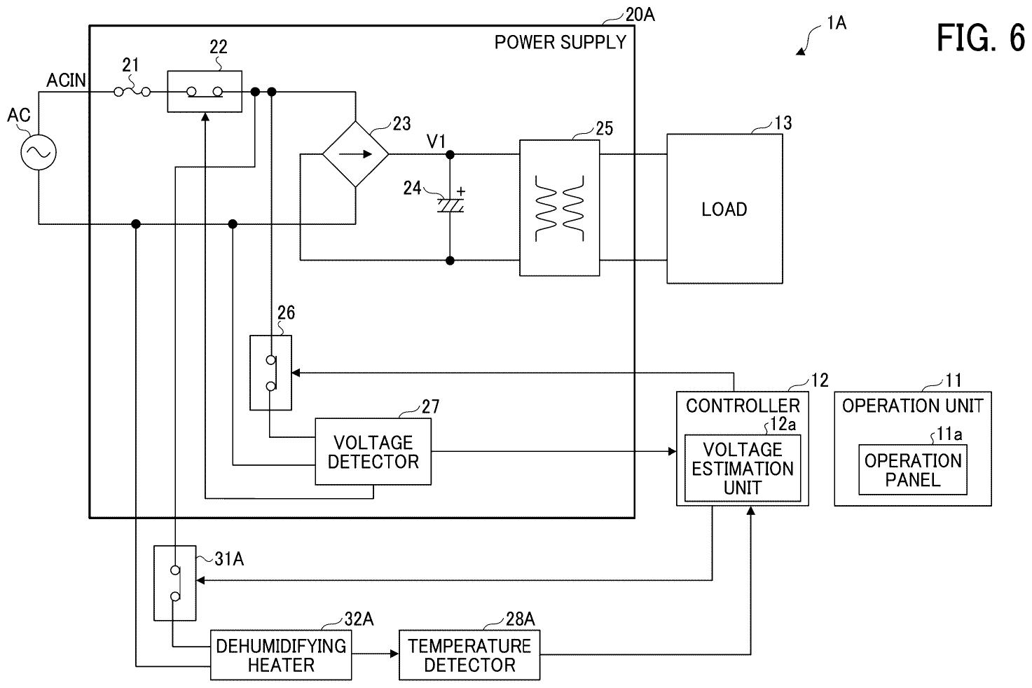

FIG. 6 is a block diagram of a part of an image forming apparatus 1A according to a second embodiment of the present disclosure. Elements similar to those described with reference to FIG. 2 are denoted by the same reference numerals, and a detailed description thereof may be omitted. The overall configuration of the image forming apparatus 1A illustrated in FIG. 6 is the same as that of FIG. 1, and the image forming apparatus 1A is, for example, a digital multi-function peripheral.

The image forming apparatus 1A includes a power supply 20A having a configuration obtained by excluding the state detector 28 from the power supply 20 of FIG. 1. The image forming apparatus 1A includes a switch 31A, a dehumidification heater 32A, and a temperature detector 28A instead of the state detector 28 in FIG. 1. The dehumidification heater 32A is an example of a heat generator and a functional unit that generate heat in response to the AC voltage ACIN. The temperature detector 28A is an example of a state detector.

The switch 31A is disposed between the output of the power interrupter 22 and the dehumidification heater 32A. The switch 31A is set to a conductive state (ON) by a control signal received from controller 12, and supplies the AC voltage ACIN output from the power interrupter 22 to the dehumidification heater 32A.

The dehumidification heater 32A is disposed in, for example, a storage space in which the sheet feed tray 10 is stored, and prevents paper jam and curling which are likely to occur when the paper medium in the sheet feed tray 10 is moistened. The dehumidification heater 32A operates during a period in which the switch 31A of FIG. 6 is on. The dehumidification heater 32A may be disposed not only in the storage space of the sheet feed tray 10 but also near the image reading device 3 and the photoconductor drum 6 to prevent condensation.

For example, the dehumidification heater 32A is a nichrome-wire heater that operates by receiving the AC voltage ACIN, and the rated voltage value of the dehumidification heater 32A is changed for each shipping country of the image forming apparatus 1. For example, the dehumidification heater 32A including a heater having a rated voltage higher than 110V is used in the image forming apparatus 1 used in Japan in which the AC voltage ACIN is 100V±10V. The dehumidification heater 32A including a heater having a rated voltage higher than 240V is used in the image forming apparatus 1 used in Europe in which the AC voltage ACIN is 230V±10V. If a voltage higher than the rated voltage is continuously applied to the dehumidification heater 32A, the heater may abnormally generate heat, and a protective thermal fuse installed on the dehumidification heater 32A may melt. Thus, the dehumidification heater 32A may be damaged.

The dehumidification heater 32A operates with the AC voltage ACIN supplied via the switch 31A during the energy saving mode in which the load 13 does not operate or when the power of the image forming apparatus 1 is off. During the energy saving mode or the off state of the power supply in which humidity is likely to be high, the controller 12 turns on the switch 31A to operate the dehumidification heater 32A.

The temperature detector 28A detects the temperature of the dehumidification heater 32A that generates heat in response to the AC voltage ACIN, and notifies the controller 12 of temperature information indicating the detected temperature. When the temperature of the dehumidification heater 32A indicated by the temperature information indicates a sign of overvoltage of the AC voltage ACIN, the controller 12 outputs a control signal that turns on the switch 26 to the switch 26, and outputs a control signal that turns off the switch 31A to the switch 31A.

The temperature of the dehumidification heater 32A at which the sign of overvoltage of the AC voltage ACIN is indicated varies depending on, for example, the rated power of the dehumidification heater 32A, the mounting structure of the dehumidification heater 32A, or the ambient temperature. Accordingly, it is preferable that the temperature at which the voltage estimating unit 12a detects the sign of overvoltage of the AC voltage ACIN is evaluated in advance by using the actual image forming apparatus 1.

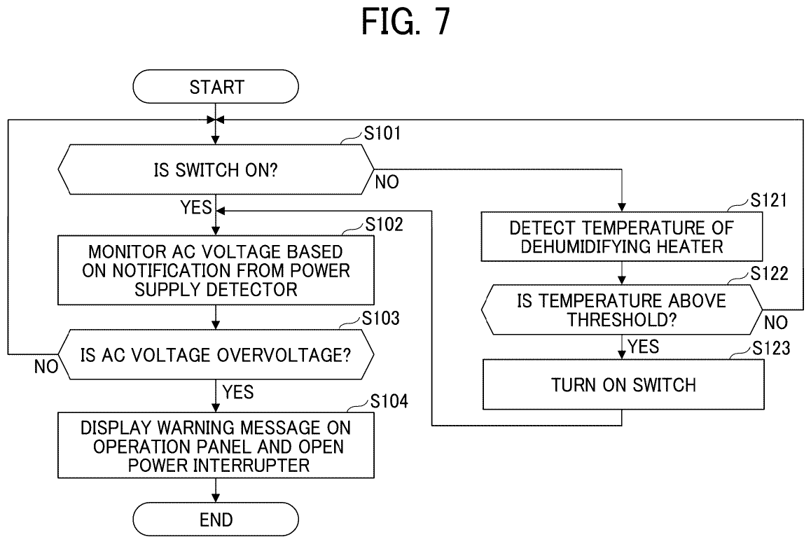

FIG. 7 is a flowchart of an operation for protecting the power supply 20A of FIG. 6 from overvoltage. The same step numbers are assigned to the same processes as those in FIG. 5, and a detailed description thereof may be omitted. The procedure illustrated in FIG. 7 is executed by the controller 12. FIG. 7 is similar to the operation of FIG. 5 except that steps S121, S122, and S123 are performed instead of steps S111, S112, and S113 of FIG. 5.

When the switch 26 is off in step S101 (in the case of the energy saving mode), the controller 12 detects the temperature of the temperature detector 28A based on the temperature information from the temperature detector 28A in step S121. The controller 12 may determine whether the switch 31A is turned on before step S121 is performed, and may perform step S121 only when the switch 31A is on.

Next, when the temperature detected in step S121 is equal to or greater than a predetermined threshold value in step S122, the controller 12 (the voltage estimation unit 12a) determines that there is a sign of overvoltage in the AC voltage ACIN, and performs step S123. When the detected temperature is less than the threshold value, the controller 12 (the voltage estimation unit 12a) determines that there is no sign of overvoltage in the AC voltage ACIN, and returns to step S101. The controller 12 turns on the switch 26 in step S123, and performs step S102. The operation after step S102 is the same as that in FIG. 5.

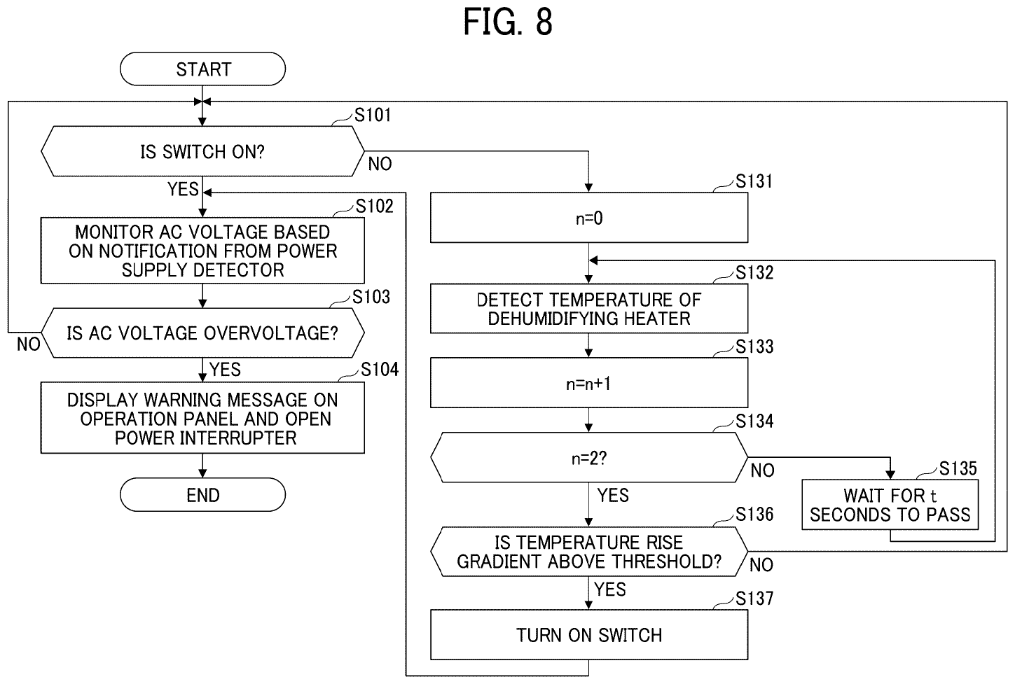

FIG. 8 is a flowchart of an operation of protecting the power supply 20A of FIG. 6 from overvoltage. The same step numbers are assigned to the same processes as those in FIG. 5, and a detailed description thereof may be omitted. FIG. 8 is similar to the operation of FIG. 5 except that steps $131, S132, S133, S134, S135, S136, and S137 are performed instead of steps S111, S112, and S113 of FIG. 5.

When the switch 26 is off in step S101 (in the case of the energy saving mode), the controller 12 performs step S131. In step S131, the controller 12 sets a variable n to zero. The controller 12 determines whether the switch 31A is on before the controller 12 performs step S131, and may perform step S131 only when the switch 31A is on.

Next, in step S132, the controller 12 detects the temperature of the dehumidification heater 32A based on the temperature information from the temperature detector 28A. In step S133, the controller 12 adds one to the variable n. When the variable n is two in step S134, the controller 12 performs step S136. When the variable n is not two (that is, when the variable n is one) in step S134, the controller 12 performs step S135.

In step S135, the controller 12 waits for t seconds to elapse, and then returns to step S132. In step S136, the controller 12 (voltage estimation unit 12a) obtains a difference between the temperatures detected in two rounds of step S132 as a temperature rise gradient. When the temperature rise gradient is equal or greater than to a predetermined threshold value, the controller 12 (voltage estimating unit 12a) determines that there is a sign of overvoltage in the AC voltage ACIN, and performs step S137. When the temperature rise gradient is less than the threshold value, the controller 12 (voltage estimation unit 12a) determines that there is no sign of overvoltage in the AC voltage ACIN, and returns to step S101. In step S137, the controller 12 turns on the switch 26 and performs step S102. The operation after step S102 is the same as that in FIG. 5.

As described above, also in the second embodiment, the same effects as the first embodiment can be obtained. For example, the operation of the voltage detector 27 that detects overvoltage of the AC voltage ACIN is performed in the normal mode and stopped in the energy saving mode. Such a configuration can detect the overvoltage of the AC power supply while reducing power consumption. In the second embodiment, the controller 12 determines whether there is a sign of overvoltage of the AC voltage ACIN based on the temperature or the temperature rise gradient of the dehumidification heater 32A operable during the energy saving mode.

### Third Embodiment

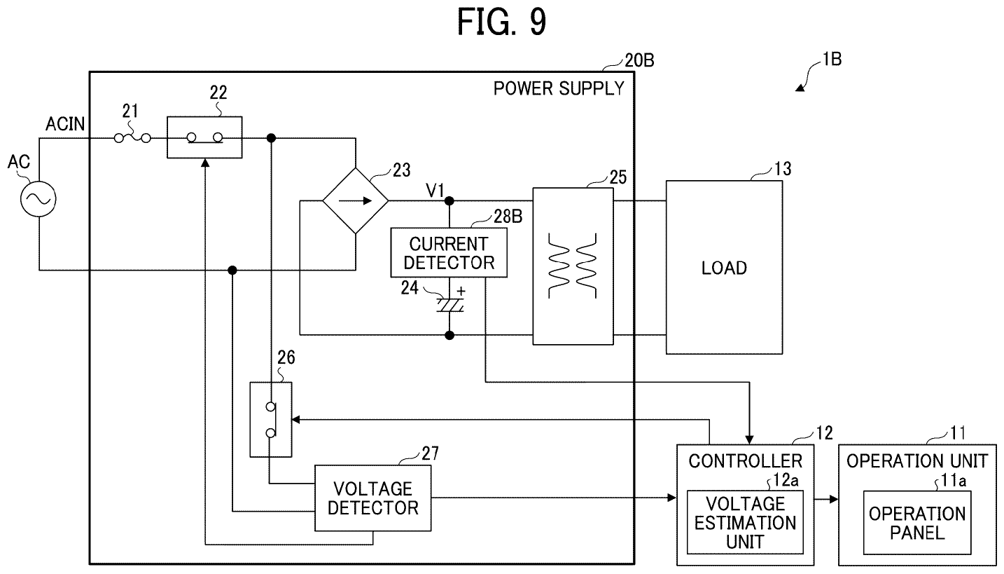

FIG. 9 is a block diagram of an image forming apparatus 1B according to a third embodiment of the present disclosure. Elements similar to those described with reference to FIG. 2 are denoted by the same reference numerals, and a detailed description thereof may be omitted. The overall configuration of the image forming apparatus 1B illustrated in FIG. 9 is the same as that of FIG. 1, and the image forming apparatus 1B is, for example, a digital multi-function peripheral.

The image forming apparatus 1B includes a power supply 20B having a configuration in which a current detector 28B to the power supply 20 of FIG. 1. The current detector 28B is disposed between the electrolytic capacitor 24 and the voltage line V1 connected to the output of the rectifier circuit 23, and detects the current flowing through the electrolytic capacitor 24. The current detector 28B notifies the controller 12 of current information indicating the detected current. The current detector 28B is an example of a state detector that detects a current flowing through the electrolytic capacitor 24.

When the current flowing through the electrolytic capacitor 24 indicated by the current information indicates a sign of overvoltage of the AC voltage ACIN during the energy saving mode, the controller 12 outputs a control signal that turns on the switch 26 to the switch 26. As in the first embodiment, such a configuration can operate the voltage detector 27, which is stopping the operation during the energy saving mode, when the value of the AC voltage ACIN indicates a sign of overvoltage.

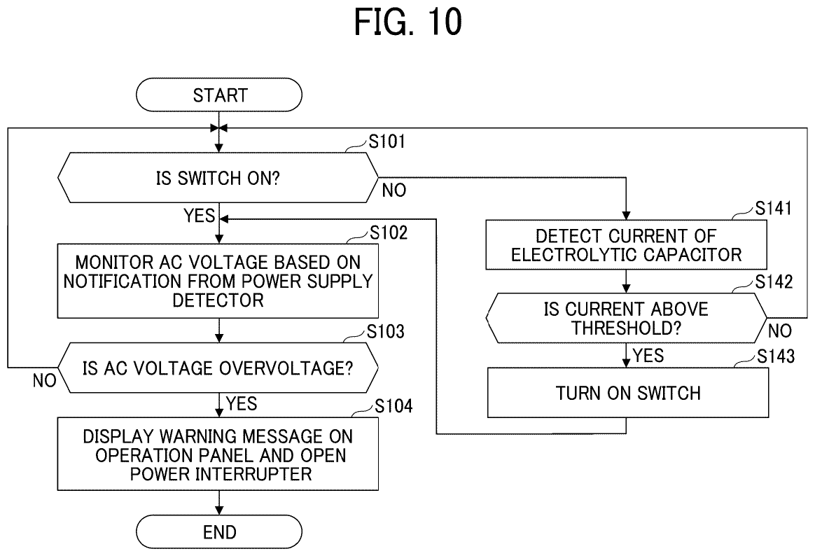

FIG. 10 is a flowchart of an operation of protecting the power supply 20B of FIG. 9 from overvoltage. The same step numbers are assigned to the same processes as those in FIG. 5, and a detailed description thereof may be omitted. The procedure illustrated in FIG. 10 is performed by the controller 12. FIG. 10 is similar to the operation of FIG. 5 except that steps S141, S142, and S143 are performed instead of steps S111, S112, and S113 of FIG. 5.

When the switch 26 is off in step S101 (in the case of the energy saving mode), the controller 12 detects the current flowing through the electrolytic capacitor 24 based on the current information from the current detector 28B in step S141. Next, when the current detected in step S141 is equal to or greater that a predetermined value in step S142, the controller 12 (voltage estimation unit 12a) determines that the AC voltage ACIN has a sign of overvoltage, and performs step S143. When the detected current is less than the threshold value, the controller 12 (voltage estimation unit 12a) determines that there is no sign of overvoltage in the AC voltage ACIN, and returns to step S101. The controller 12 turns on the switch 26 in step S143, and performs step S102. The operation after step S102 is the same as that in FIG. 5.

As described above, also in the third embodiment, the same effects as the first embodiment can be obtained. For example, the operation of the voltage detector 27 that detects overvoltage of the AC voltage ACIN is performed in the normal mode and stopped in the energy saving mode. Such a configuration can detect the overvoltage of the AC power supply while reducing power consumption. Further, in the third embodiment, the controller 12 determines whether there is a sign of overvoltage of the AC voltage ACIN based on the value of the current flowing through the electrolytic capacitor 24 which is charged and discharged even during the energy saving mode.

### Fourth Embodiment

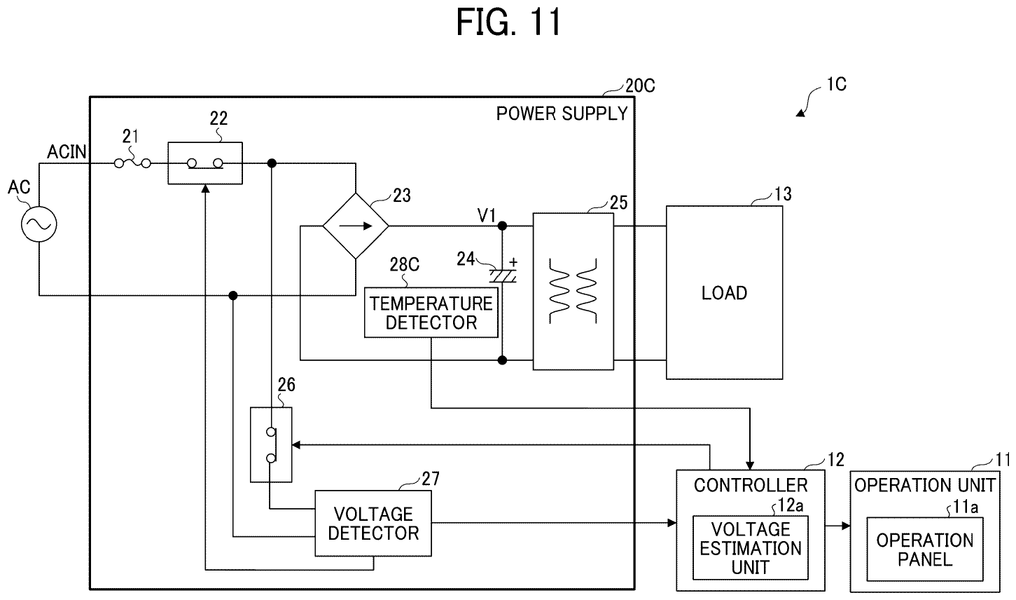

FIG. 11 is a block diagram of an image forming apparatus 1C according to a fourth embodiment of the present disclosure. Elements similar to those described with reference to FIG. 2 are denoted by the same reference numerals, and a detailed description thereof may be omitted. The overall configuration of the image forming apparatus 1C illustrated in FIG. 11 is the same as that of FIG. 1, and the image forming apparatus 1C is, for example, a digital multi-function peripheral.

The image forming apparatus 1C includes a power supply 20C having a configuration in which a temperature detector 28C is added to the power supply 20 of FIG. 1. The temperature detector 28C is disposed near the electrolytic capacitor 24 and detects the temperature of the electrolytic capacitor 24. The temperature detector 28C notifies the controller 12 of temperature information indicating the detected temperature. The current detector 28B is an example of a state detector that detects the temperature of the electrolytic capacitor 24.

When the temperature of the electrolytic capacitor 24 indicated by the voltage information indicates a sign of overvoltage of the AC voltage ACIN during the energy saving mode, the controller 12 outputs a control signal that turns on the switch 26 to the switch 26. As in the first embodiment and the third embodiment, such a configuration can operate the voltage detector 27, which is stopping the operation during the energy saving mode, when the value of the AC voltage ACIN indicates a sign of overvoltage.

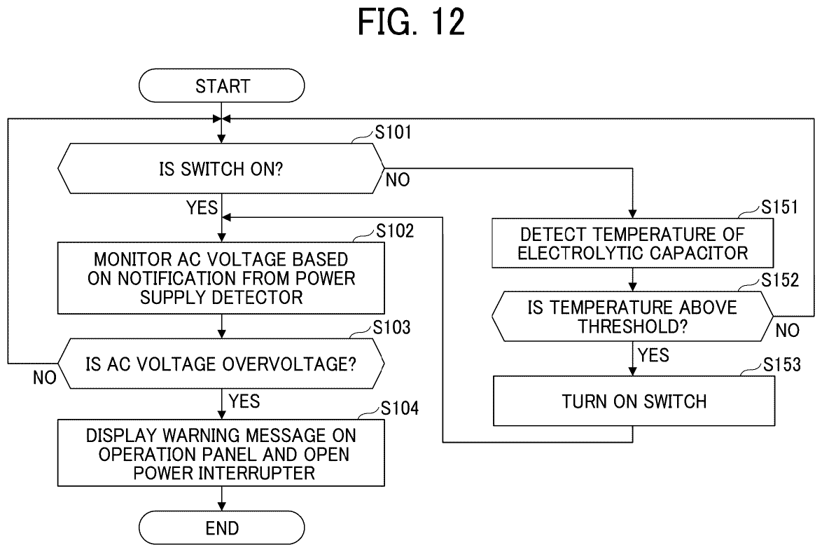

FIG. 12 is a flowchart of an operation of protecting the power supply 20C of FIG. 11 from overvoltage. The same step numbers are assigned to the same processes as those in FIG. 5, and a detailed description thereof may be omitted. The procedure illustrated in FIG. 12 is performed by the controller 12. FIG. 12 is similar to the operation of FIG. 5, except that steps S151, S152, and S153 are performed instead of steps S111, S112, and S113 of FIG. 5.

When the switch 26 is off in step S101 (in the case of the energy saving mode), in step S151, the controller 12 detects the temperature of the electrolytic capacitor 24 based on the temperature information from the temperature detector 28C. Next, when the temperature detected in step S151 is equal to or greater than a predetermined value in step S152, the controller 12 (voltage estimation unit 12a) determines that there is a sign of overvoltage in the AC voltage ACIN, and performs step S153. When the detected temperature is less than the threshold value, the controller 12 (the voltage estimation unit 12a) determines that there is no sign of overvoltage in the AC voltage ACIN, and returns to step S101. The controller 12 turns on the switch 26 in step S153, and performs step S102. The operation after step S102 is the same as that in FIG. 5.

As described above, also in the fourth embodiment, the same effects as the first embodiment can be obtained. For example, the operation of the voltage detector 27 that detects the overvoltage of the AC voltage ACIN is performed in the normal mode and stopped in the energy saving mode. Such a configuration can detect the overvoltage of the AC power supply while reducing power consumption. Further, in the fourth embodiment, the controller 12 determines whether there is a sign of overvoltage of the AC voltage ACIN based on the temperature of the electrolytic capacitor 24 which is charged and discharged even during the energy saving mode.

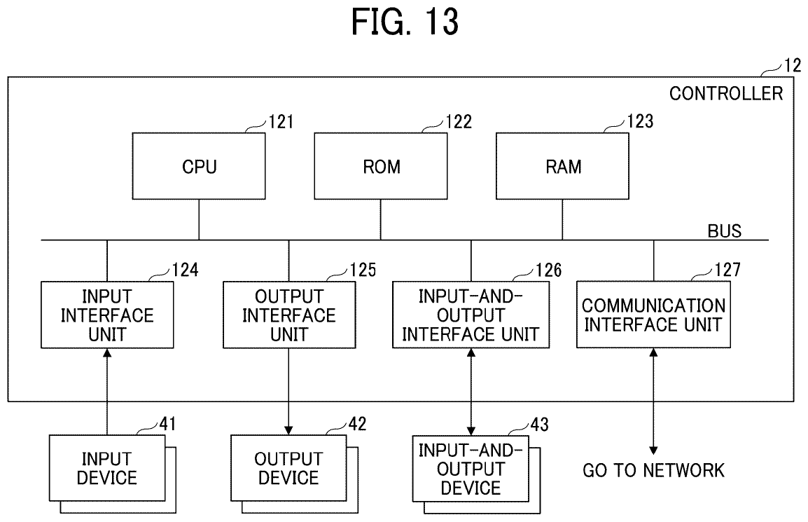

FIG. 13 is a block diagram of a hardware configuration of the controller 12 illustrated in FIGS. 1 and 2. The controller 12 includes a central processing unit (CPU) 121, a read-only memory (ROM) 122, and a random-access memory (RAM) 123. The controller 12 includes an input interface unit 124, an output interface unit 125, an input-and-output interface unit 126, and a communication interface unit 127.

For example, the CPU 121, the ROM 122, the RAM 123, the input interface unit 124, the output interface unit 125, the input-and-output interface unit 126, and the communication interface unit 127 are connected to each other via a bus.

The CPU 121 executes various programs such as an operating system (OS) and applications. The ROM 122 holds, for example, a basic program and various parameters that execute various programs by the CPU 121. The RAM 123 stores, for example, the various programs executed by the CPU 121 and data used in the programs. For example, the various programs may include an image processing program that performs image processing on a document image read by the image reading device 3 and a power supply control program that controls the power supply 20. The various programs may include a control program that causes the controller 12 to operate as the voltage estimation unit 12a.

For example, an input device 41 such as an input unit mounted to the operation unit 11 of the image reading apparatus 3 and the image forming apparatus 1 is connected to the input interface unit 124. An output device 42 such as the operation panel 11a mounted to the operation unit 11 is connected to the output interface unit 125. An input-and-output device 43 such as an auxiliary storage device and a recording medium is connected to the input-and-output interface unit 126. The communication interface unit 127 can connect the image forming apparatus 1 to, for example, a network.

In a case where various programs such as the image processing program or the power supply control program are stored in a recording medium, the programs may be transferred from the recording medium to, for example, the RAM 123 via the input-and-output interface unit 126 to which the recording medium is connected.

Aspects of the present disclosure are, for example, as follows.

### First Aspect

An image forming apparatus (e.g., the image forming apparatus 1) includes an image forming device (e.g., the printer unit 5), a voltage detector (e.g., the voltage detector 27), a switch (e.g., the switch 26), a functional unit (e.g., dehumidification heater 32A), a state detector (e.g., the state detector 28), and a controller (e.g., the controller 12). The image forming device forms an image based on an AC voltage input from an external device. The voltage detector detects a value of the AC voltage. The switch switches between a conductive state and a cutoff state of a current path of the AC voltage to the voltage detector. The functional unit generates heat or allows a current to flow in response to the AC voltage. The state detector detects a temperature or the current of the functional unit. The controller estimates a value of the AC voltage based on the temperature or the current detected by the state detector. When the value of the AC voltage estimated by the controller indicates a sign of overvoltage, the controller switches the switch in the cutoff state to the conductive state.

### Second Aspect

In the image forming apparatus (e.g., the image forming apparatus 1) according to the first aspect, the functional unit is a heat generator (e.g., the dehumidification heater 32A) that generates heat in response to the AC voltage. The state detector (e.g., the state detector 28) detects a temperature of the heat generator. When the temperature of the heat generator detected by the state detector is equal to or greater than a threshold value, the controller (e.g., the controller 12) determines that the value of the AC voltage indicates the sign of overvoltage.

### Third Aspect

In the image forming apparatus (e.g., the image forming apparatus 1) according to the first aspect, the functional unit is a heat generator (e.g., the dehumidification heater 32A) whose temperature changes in response to a change in the AC voltage. The state detector (e.g., the state detector 28) detects the temperature of the heat generator. When a temperature rise gradient of the temperature detected a plurality of times by the state detector at a time interval is equal to or greater than a threshold value, the controller (e.g., the controller 12) determines that the value of the AC voltage indicates the sign of overvoltage.

### Fourth Aspect

In the image forming apparatus (e.g., the image forming apparatus 1) according to the first aspect, the functional unit is an electrolytic capacitor (e.g., the electrolytic capacitor 24) that is charged based on the AC voltage. The state detector (e.g., the state detector 28) detects a current flowing through the electrolytic capacitor. When the current of the electrolytic capacitor detected by the state detector is equal to or greater than a threshold value, the controller (e.g., the controller 12) determines that the value of the AC voltage indicates the sign of overvoltage.

### Fifth Aspect

In the image forming apparatus (e.g., the image forming apparatus 1) according to the first aspect, the functional unit is an electrolytic capacitor (e.g., the electrolytic capacitor 24) that is charged based on the AC voltage. The state detector (e.g., the state detector 28) detects a temperature of the electrolytic capacitor. When the temperature of the electrolytic capacitor detected by the state detector is equal to or greater than a threshold value, the controller (e.g., the controller 12) determines that the value of the AC voltage indicates the sign of overvoltage.

### Sixth Aspect

The image forming apparatus (e.g., the image forming apparatus 1) according to any one of the first to fifth aspects further includes a display (e.g., the operation panel 11a) that can display information. When the controller (e.g., the controller 12) determines that the value of the AC voltage indicates the sign of overvoltage, the controller causes the display to display a warning message.

### Seventh Aspect

The image forming apparatus (e.g., the image forming apparatus 1) according to any one of the first to sixth aspects further includes a power interrupter (e.g., the power interrupter 22) that is disposed in an input unit (e.g., the input device 41) of the AC voltage and can cut off input of the AC voltage. When the voltage detector (e.g., the voltage detector 27) detects that the AC voltage is an overvoltage, the voltage detector causes the power interrupter to cut off the input of the AC voltage.

### Eighth Aspect

The image forming apparatus (e.g., the image forming apparatus 1) according to any one of the first to seventh aspects has an energy saving mode in which the image forming device (e.g., the printer unit 5) stops forming an image. The controller (e.g., the controller 12) sets the switch (e.g., the switch 26) to the cutoff state during the energy saving mode. The voltage detector (e.g., the voltage detector 27) stops a detection operation of the AC voltage during the energy saving mode.

### Ninth Aspect

In the image forming apparatus (e.g., the image forming apparatus 1) according to the eighth aspect, the controller (e.g., the controller 12) estimates a value of the AC voltage based on the temperature or the current detected by the state detector (e.g., the state detector 28) during the energy saving mode. When the controller determines that the value of the AC voltage estimated by the controller indicates the sign of overvoltage, the controller switches the switch (e.g., the switch 26) in the cutoff state to the conductive state.

### Tenth Aspect

A control method is for an image forming apparatus (e.g., the image forming apparatus 1) that includes an image forming device (e.g., the printer unit 5) and a functional unit. The image forming device forms an image based on an AC voltage input from an external device. The functional unit generates heat or allows a current to flow in response to the AC voltage. In the method, a voltage detector (e.g., the voltage detector 27) of the image forming apparatus detects a value of the AC voltage. A switch (e.g., the switch 26) of the image forming apparatus switches between a conductive state and a cutoff state of a current path of the AC voltage to the voltage detector. A state detector (e.g., the state detector 28) of the image forming apparatus detects a temperature or the current of the functional unit. A controller (e.g., the controller 12) of the image forming apparatus estimates a value of the AC voltage based on the temperature or the current detected by the state detector (e.g., the state detector 28). When the estimated value of the AC voltage indicates a sign of overvoltage, the controller switches the switch in the cutoff state to the conductive state.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image forming apparatus comprising:
an image forming device to form an image based on an alternating current (AC) voltage input from an external device;
a voltage detector to detect a value of the AC voltage;
a switch to switch between a conductive state and a cutoff state of a current path of the AC voltage to the voltage detector;
a functional unit to generate heat or allow a current to flow in response to the AC voltage;
a state detector to detect a temperature or the current of the functional unit; and
circuitry configured to:
estimate the value of the AC voltage based on the temperature or the current detected by the state detector; and
switch the switch from the cutoff state to the conductive state when the value of the AC voltage estimated by the circuitry indicates a sign of overvoltage.

2. The image forming apparatus according to claim 1,
wherein the functional unit is a heat generator that generates heat in response to the AC voltage,
wherein the state detector detects a temperature of the heat generator, and
wherein the circuitry determines that the value of the AC voltage indicates the sign of overvoltage when the temperature of the heat generator detected by the state detector is equal to or greater than a threshold value.

3. The image forming apparatus according to claim 1,
wherein the functional unit is a heat generator whose temperature changes in response to a change in the AC voltage,
wherein the state detector detects the temperature of the heat generator, and
wherein the circuitry determines that the value of the AC voltage indicates the sign of overvoltage, when a temperature rise gradient of the temperature detected a plurality of times by the state detector at a time interval is equal to or greater than a threshold value.

4. The image forming apparatus according to claim 1,
wherein the functional unit is an electrolytic capacitor that is charged based on the AC voltage,
wherein the state detector detects a current flowing through the electrolytic capacitor, and
wherein the circuitry determines that the value of the AC voltage indicates the sign of overvoltage, when the current of the electrolytic capacitor detected by the state detector is equal to or greater than a threshold value.

5. The image forming apparatus according to claim 1,
wherein the functional unit is an electrolytic capacitor that is charged based on the AC voltage,
wherein the state detector detects a temperature of the electrolytic capacitor, and
wherein the circuitry determines that the value of the AC voltage indicates the sign of overvoltage, when the temperature of the electrolytic capacitor detected by the state detector is equal to or greater than a threshold value.

6. The image forming apparatus according to claim 1, further comprising a display to display information,
wherein the circuitry causes the display to display a warning message when the circuitry determines that the value of the AC voltage indicates the sign of overvoltage.

7. The image forming apparatus according to claim 1, further comprising a power interrupter to cut off input of the AC voltage,
wherein the voltage detector causes the power interrupter to cut off the input of the AC voltage when the voltage detector detects that the AC voltage is an overvoltage.

8. The image forming apparatus according to claim 1,
wherein the circuitry sets the switching to the cutoff state during an energy saving mode in which the circuitry stops supply of power to the image forming device, and
wherein the voltage detector stops a detection operation of the AC voltage during the energy saving mode.

9. The image forming apparatus according to claim 8,
wherein the circuitry estimates the value of the AC voltage based on the temperature or the current detected by the state detector during the energy saving mode, and
wherein the circuitry switches the switch from the cutoff state to the conductive state when the circuitry determines that the value of the AC voltage estimated by the circuitry indicates the sign of overvoltage.

10. A method for controlling an image forming apparatus that includes an image forming device to form an image based on an AC voltage input from an external device, a functional unit to generate heat or allow a current to flow in response to the AC voltage, a voltage detector, a switch, a state detector, and circuitry, the method comprising:
detecting a value of the AC voltage by the voltage detector;
switching between a conductive state and a cutoff state of a current path of the AC voltage to the voltage detector by the switch;
detecting a temperature or the current of the functional unit by the state detector;
estimating, by the circuitry, the value of the AC voltage based on the temperature or the current detected by the state detector; and
switching, by the circuitry, the switch in the cutoff state to the conductive state.
